(19) United States
(12) Patent Application Publication
(10) Pub. No.: US 2008/0166546 A1
(43) Pub. Date: Jul. 10, 2008

(54) Optical sheet and display optical filter

(75) Inventors: Sung Nim Jo, Seoul (KR); In Sung Sohn, Seongnam-si (KR); Sang Cheol Jung, Suwon-si (KR); Eun Young Cho, Seoul (KR)

Correspondence Address: MCDERMOTT WILL & EMERY LLP, 600 13TH STREET, N.W., WASHINGTON, DC, 20005-3096, US

(73) Assignee: SAMSUNG CORNING CO., LTD.

(21) Appl. No.: 12/003,989

(22) Filed: Jan. 4, 2008

(30) Foreign Application Priority Data
Jan. 5, 2007 (KR) 10-2007-0001460

(51) Int. Cl. B32B 7/12

(52) U.S. Cl. 428/332; 428/354

(57) ABSTRACT

An optical sheet, including: a transparent material; a light absorption pattern formed on a side of the transparent material; and a flexible adhesion layer formed on the side of the transparent material in which the light absorption pattern is formed.

### CROSS-REFERENCE TO RELATED APPLICATION

This application claims the benefit of Korean Patent Application No. 10-2007-0001460, filed on Jan. 5, 2007, in the Korean Intellectual Property Office, the disclosure of which is incorporated herein by reference.

### BACKGROUND OF THE INVENTION

1. Field of the Invention

The present invention relates to a display optical filter, and more particularly, to an optical sheet and a display optical filter which can reduce image distortion and increase a sharpness of image.

2. Description of Related Art

In general, a Plasma Display Panel (PDP) apparatus has a defect in that an amount of emitted electromagnetic (EM) radiation and near infrared (NI) radiation generated in the PDP apparatus is great in terms of the driving characteristic, and thus it may have harmful effects on human bodies, and cause sensitive equipments such as wireless telephones, remote controls, and the like, to malfunction.

Therefore, in order to use the PDP apparatus, it is required to prevent emission of EM radiation and NI radiation emitted from the PDP apparatus from increasing to more than a predetermined level. In this manner, a filter in which functional films are stacked and positioned on a front surface of the PDP apparatus is referred to as a PDP filter.

The PDP apparatus has functions such as Electromagnetic Interference (EMI) shielding function, NI radiation (NIR) shielding function for regulating a remote control and preventing infrared rays from causing communication failure, enhancement of color purity function in which orange light emitted from a neon gas, used as a discharging gas of the PDP apparatus, is absorbed and thereby enhancing color purity and also enhancing anti-reflection functionality of preventing external light from being reflected. Currently, the PDP apparatus has an external light absorption function for enhancing a contrast ratio in a bright room.

An optical film having the external light absorption function is manufactured by filling a black material, which has a light absorption property, into grooves or patterns of a transparent film. But, when filling the black material on the film, the optical film can have a fine seam between a pattern film and black stripe, so as to have a not-flat surface. When a pattern of an optical structure, having a seam interfacing two different materials, is used alone, a diffused reflection of a display light source may occur due to an uneven surface. Also, an image cannot be clear and can be blurred due to the diffused reflection.

Thus, a new optical sheet and display optical filter is required.

### BRIEF SUMMARY

An aspect of the present invention provides an optical sheet and display optical filter which can provide improved definition.

An aspect of the present invention also provides an optical sheet and display optical filter which can prevent a diffused reflection from occurring in a border between a bottom surface of a light absorption pattern and a transparent material.

An aspect of the present invention also provides an optical sheet and display optical filter which can remove a fine seam which can be generated on a surface of a transparent material and a bottom surface of a light absorption pattern, and thereby can reduce image distortion.

According to an aspect of the present invention, there is provided an optical sheet which includes a transparent material, a light absorption pattern, and a flexible adhesion layer. Generally, the light absorption pattern is formed on a side of the transparent material, and a bottom surface of the light absorption pattern faces an inside of a Plasma Display Panel (PDP) apparatus, that is, incident light, on the optical filter. The flexible adhesion layer is formed on the side of the transparent material in which the light absorption pattern is formed, and thus a fine seam due to the light absorption pattern can be alleviated or removed.

The transparent material is a type of film where light can pass through, and can be a transparent film material such as a polyethylene terephthalate (PET), polycarbonate (PC), and the like. The light absorption pattern can be used on the transparent material in various ways. For example, a plurality of grooves is formed in the transparent material and the light absorption pattern is provided to fill the grooves. Also, other methods can be used.

The flexible adhesion layer is formed of a flexible adhesive which is coated on a side of the transparent material. The bottom surface of the light absorption pattern is formed on the side of the transparent material. In this instance, the flexible adhesive can include at least one absorption dye or pigment which can selectively absorb a particular wavelength. Also, the flexible adhesive can include at least one absorption dye or pigment which can absorb near-infrared rays. Here, flexibility can indicate flexibility within a temperature range of 50° C. to 150° C. and under a pressure of 1 Kgf/cm².

A display optical filter including the optical filter according to an exemplary embodiment of the present invention can have an improved contrast ratio in a bright room, prevent a display image definition from being degraded in comparison with a display optical filter without the flexible adhesion layer, and prevent an image from being distorted. That is, according to an exemplary embodiment of the present invention, a flexible polymer resin such as an adhesive is laminated on a film with an external light absorption function, and thus a fine seam on the film surface can be removed, image distortion can be prevented, and a clear image quality can be achieved.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a partial cross-sectional view illustrating an optical sheet according to an exemplary embodiment of the present invention;

FIG. 2 is a partially enlarged view illustrating the optical sheet of FIG. 1; and

FIG. 3 is a cross-sectional view illustrating a display optical filter according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

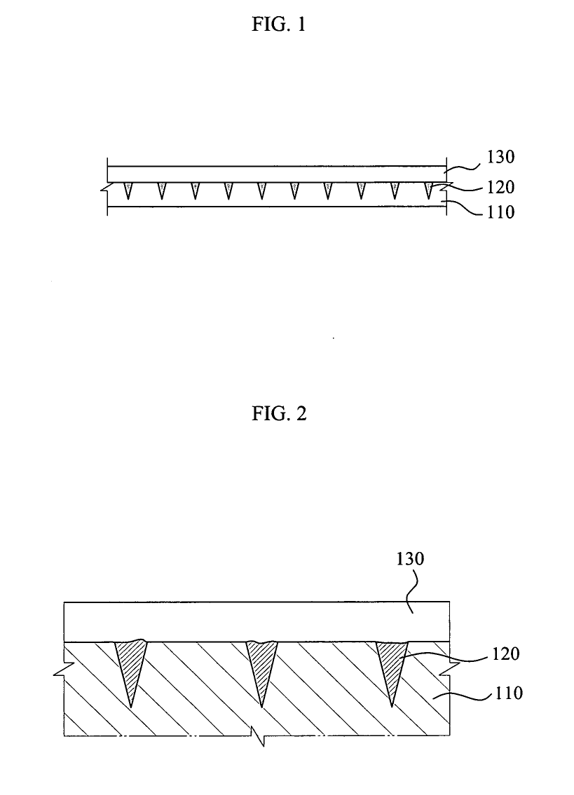

FIG. 1 is a partial cross-sectional view illustrating an optical sheet according to an exemplary embodiment of the present invention. FIG. 2 is a partially enlarged view illustrating the optical sheet of FIG. 1.

Referring to FIGS. 1 and 2, the optical sheet includes a transparent film 110, a light absorption pattern 120, and a flexible adhesion layer 130. A plurality of wedge-shaped grooves is formed on a side of the transparent film 110. The light absorption pattern 120 can be provided to fill the plurality of grooves.

The transparent film 110 may be used as a transparent material, and whose material may be polyethylene terephthalate (hereinafter, referred to as ‘PET’) acryl, polycarbonate (hereinafter, referred to as ‘PC’), urethane acrylate, polyester, epoxy acrylate, brominate acrylate, and the like.

The plurality of grooves is formed on a surface of the transparent film 110. The plurality of grooves has a wedge-shaped section, and provided in parallel at regular intervals in a stripe form. According to another exemplary embodiment of the present invention, a plurality of lens-shaped grooves can be provided. The plurality of lens-shaped grooves can be two-dimensionally distributed.

Various methods for forming a plurality of pattern grooves on a transparent film may be used. According to one method, a UV hardener is coated on a surface of a transparent film, a protrusive wedge-shaped article is pressurized on the surface coated with the UV hardener, whereby a plurality of grooves having a perfect mirror image of the protrusive wedge-shape is formed on the transparent film. Subsequently, the transparent film is exposed to ultraviolet rays, and consequently a plurality of pattern grooves formed on the transparent film is obtained.

Alternatively, for forming a plurality of grooves on the transparent film, a heated die may be used. Specifically, a desired-shaped groove may be formed by pressurizing the heated die on a thermoplastic resin through a heat press method. Also, a casting method in which a thermoplastic resin composition is poured into the die and hardened, thereby forming a groove corresponding to the die, may be used. An injection molding method similar to the above mentioned-methods may be also used.

As illustrated in FIG. 1, the transparent film 110 may have grooves, such that the remaining portions except the grooves can serve as an optical lens. A resin including a colorant, such as a black pigment, a carbon black, and the like, which are light absorbent materials, is filled in the groove of the transparent film 110 using a wiping method, and hardened by ultraviolet rays. Here, a mixed material, in which a carbon nanotube (CNT), a copper oxide, an indium tin oxide (ITO), and the like, is mixed with a highly conductive polymer, may be used as the colorant, thereby achieving an Electro Magnetic Interference (EMI) shielding function. Here, a width of the light-shielding pattern 120 may be 10 μm to 50 μm.

After forming the light absorption pattern 120, the flexible adhesion layer 130 is formed on the side of the transparent film 110. A thickness of the flexible adhesion layer 130 can be in a range of 10 μm to 50 μm, which is formed using a flexible polymer resin. A diffused reflection due to unevenness and curvature can be prevented. The flexible adhesive includes all kinds of resins having flexibility at room temperature. For example, an ethyl acrylate, methyl acrylate, butyl acrylate, and the like, which have a high transparency, can be used as the flexible adhesive. Also, an acrylic resin which uses at least one of the above-described materials as a copolymer monomer can be used as the flexible adhesive. Also, a carboxyl group-containing methacrylate such as an acrylic acid and methacrylic acid, hydroxymethyl methacrylic acid, 2-hydroxyethyl methacrylic acid, and the like can be used as the flexible adhesive. The flexible adhesive maintains flexibility within a temperature range of 50° C. to 150° C. and under a pressure of 1 Kgf/cm².

The acrylic resin has excellent mechanical strength, and has a high transparency in a visible wavelength range. As a lamination method, a flexible polymer can be coated on an external light absorption function sheet. Also, a flexible polymer layer coated on another material is pressed and attached to the external light absorption function sheet.

Also, a refractive index of the flexible adhesion layer 130 can be in a range of 1.45 to 1.6 in order to prevent image distortion due to the flexible adhesion layer 130. A difference of refractive indexes between the flexible adhesion layer 130 and the transparent film 110 can be less than 0.12.

According to another exemplary embodiment of the present invention, the flexible adhesion layer 130 can be used for adhesive purposes alone or the flexible adhesion layer 130 can provide additional functionality. For example, when the display optical filter is applied to a PDP filter, a near-infrared absorption dye or pigment and a dye or pigment_absorbing wavelengths of a particular range can be added, and thus a near-infrared shielding function and color correction function can occur together or separately.

Generally, inorganic dyes and pigments_and organic dyes can be used as the near-infrared absorption dye or pigment. The inorganic pigment includes a cobalt pigment, iron pigment, chrome pigment, titanium pigment, and the like. The organic dye includes a dimonium dye, anthraquinone dye, aminium dye, polymethine dye, azo dye, dithiol metal complex dye, and the like.

The organic pigment or dye_can be mainly used for the flexible adhesion layer 130 due to possessing transparency. Particularly, the polymethine dye and dimonium dye can be widely used in terms of colors. However, the present invention is not limited to a particular dye or pigment.

The anthraquinone dye, cyanine dye, azo dye, stryl dye, naphthalocyanine dye, methine dye, or compounds of the above-described dyes can be used as a selective wavelength absorption pigment of visible rays. Also, organic pigments disclosed in Korean Patent Unexamined Publication No. 2001-26838 and No. 2001-39727 can be used. The above-identified patents can be applicable to the present invention. Also, an octaphenyltetraazaphopyrine derivative can be used. Preferably, an absorption dye or pigment which has maximum absorption of wavelengths in a range of 580 nm to 600 nm can be used as the flexible adhesive.

Although dye or pigment concentration varies depending on an absorption index of the dye or pigment, a thickness of polymer layer, NIR absorption amount, and visible ray transmissivity, the dye or pigment concentration is generally 1 ppm-20 weight % to a polymer resin solid.

### Embodiment 1

A urethane-acrylic UV-cured resin is coated on a surface of an optical PET transparent film with a coated thickness of 200 μm by using a micro via. Next, a pattern groove is formed using a wedge-shaped mold, and then UV-hardened. A carbon black having an average particle size of 50 μm allows a black ink which is dispersed at about 3 wt. % to be mixed with a UV hardening resin, thereby manufacturing a black resin with a solid content of about 20%. The wedge-shaped pattern groove is filled with a light absorbent material through a wiping method in which the resin with the black ink mixed therewith is poured on the transparent film with the wedge-shaped grooves formed thereon, and then the outer surface of the transparent film is wiped. An acrylic adhesive resin having flexibility is coated on a light absorption pattern of an external light shielding function sheet, and thereby can form a flexible adhesion layer.

### Embodiment 2

In order to add an NIR absorption function and color purity enhancement function to an adhesive coated on the light absorption pattern according to the Embodiment 1 described above, an NIR absorption dye and cyanine dye are mixed with an acrylic adhesive (‘Soken’ company SK 1831) with 0.1% to 1% content, respectively. In this instance, the NIR absorption dye includes a dimonium dye (Japan Chemistry PDC 680) and naphthalocyanine dye. The cyanine dye is a selective absorption dye and has a maximum absorption of wavelengths of about 590 nm. When the adhesive with the NIR absorption function and color correction function is made, the adhesive can be coated on an external light shielding coating surface with a thickness of about 20 μm to 25 μm.

### Embodiment 3

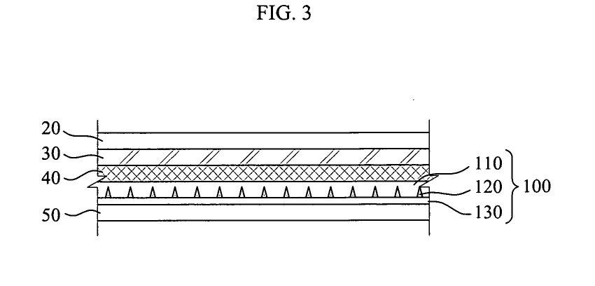

FIG. 3 is a cross-sectional view illustrating a display optical filter according to an exemplary embodiment of the present invention.

Referring to FIG. 3, an optical sheet 100 including a flexible adhesion layer manufactured according to Embodiment 1 described above is laminated on a glass substrate 30. Electromagnetic-shielding coating 40 is laminated on the glass substrate 30. A color correction film 50 is laminated on the electromagnetic-shielding coated glass substrate 30, and then an anti-reflection film 20 is attached to an opposite surface of the glass substrate 30. Accordingly, a PDP optical filter is manufactured.

A polymer layer having flexibility is coated on a surface of a black optical film with an external light absorption function, and thus an unevenness of surface is alleviated. Accordingly, a display optical filter in which a diffused reflection emitted from a display is reduced, a contrast ratio in a bright room significantly is improved, and a clear image is achieved, can be provided.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An optical sheet, comprising:
a transparent material;
a light absorption pattern formed on a side of the transparent material; and
a flexible adhesion layer formed on the side of the transparent material in which the light absorption pattern is formed.

2. The optical sheet of claim 1, wherein the flexible adhesion layer is formed of a flexible adhesive which is coated on the transparent material.

3. The optical sheet of claim 2, wherein the flexible adhesive includes an absorption dye or pigment which has maximum absorption of wavelengths in a range of 580 nm to 600 nm.

4. The optical sheet of claim 2, wherein the flexible adhesive includes a near-infrared absorption dye or pigment.

5. The optical sheet of claim 2, wherein the flexible adhesive maintains flexibility within a temperature range of 50° C. to 150° C. and under a pressure of 1 Kgf/cm².

6. The optical sheet of claim 1, wherein a thickness of the flexible adhesion layer is in a range of 10 μm to 50 μm.

7. The optical sheet of claim 1, wherein a refractive index of the flexible adhesion layer is in a range of 1.45 to 1.6.

8. The optical sheet of claim 1, wherein a difference of refractive indexes between the flexible adhesion layer and the transparent material is less than 0.12.

9. The optical sheet of claim 1, wherein a plurality of grooves are formed in the transparent material and the light absorption pattern is provided to fill the grooves.

10. The optical sheet of claim 9, wherein the groove and the light absorption pattern have a wedge-shaped section, and provided in parallel at regular intervals on the transparent material.

11. The optical sheet of claim 9, wherein a width of the light absorption pattern is in a range of 10 μm to 50 μm.

12. An optical filter including a plurality of films for a display, the optical filter comprising:
an optical sheet as one of the plurality of films, wherein the optical sheet comprises a transparent material, a light absorption pattern formed on the transparent material, and a flexible adhesion layer formed on the transparent material in which the light absorption pattern is formed.

13. The optical filter for display of claim 12, wherein the flexible adhesive layer includes at least any one of an absorption dye or pigment which has maximum absorption of wavelengths in a range of 580 nm to 600 nm, and a near-infrared absorption dye or pigment.
